(19) United States
(12) Patent Application Publication
(10) Pub. No.: US 2005/0116936 A1
(43) Pub. Date: Jun. 2, 2005

(54) Touch pad for displaying information

(75) Inventor: Ching-Jou Chen, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/841,626

(22) Filed: May 10, 2004

(30) Foreign Application Priority Data
Dec. 1, 2003 (TW) 092221131

(51) Int. Cl. G09G 5/08; G09G 5/00

(52) U.S. Cl. 345/173

(57) ABSTRACT

A touch pad for displaying information, the touch pad is disclosed to be adapted to a computer system. The touch pad comprises a calculating unit, a storage unit for storing data, a display unit having a display board and a sensitive board, and a connecting port for connecting to the computer system, wherein the calculating unit and the storage unit are integrated into a SOC connected to the display unit.

### BACKGROUND OF THE INVENTION

1. Field of the Invention

The present invention relates to a touch pad for displaying information, and particularly to a touch pad for separately and individually searching data.

2. Description of Related Art

In today's computerization era, notebook PCs or tablet PCs have been very common so that almost everyone has a notebook PC. People use computers to work and store data. Thus, the computers have become an important part of everyone's daily life. Information such as a calendar, an address book and the like is usually stored in the PCs. However, it is necessary to power up the computer when doing searches. The power-up operation wastes the user's time in waiting, causing in inconvenience to the user. In particular, when the user just wants to search a bit of information such as the calendar or address book, the time spent in waiting for powering up the computer is frequently longer than the time for searching data. This wastes time in waiting for powering up the computer. In this light, the conventional method is unable to provide the user with an effective data search, and needs to be improved.

Therefore, it is desirable to provide an improved touch pad for displaying information to mitigate and/or obviate the aforementioned problems.

### SUMMARY OF THE INVENTION

Accordingly, it is an object of the present invention to provide a touch pad for displaying information to be adapted to a computer system so that the user searches an address book, a calendar and the like by means of the touch pad without powering up the computer. The user does not waste time in waiting for powering up the computer in searching data. Also, the touch pad has advantages of small size and portable convenience, and can be always ready for the user to search data.

To attain the forgoing object, a touch pad for displaying information according to the present invention comprises a calculating unit, a storage unit for storing data, a display unit connected to the calculating unit and the storage unit wherein the display unit has a display board and a sensitive board, and a connecting port for connecting to a computer system so that the touch pad is electrically connected to and detachable from the computer system and the data stored in the storage unit and data of the computer system synchronize.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view showing an aspect of implementing a touch pad and a computer system according to the present invention.

FIG. 2 is a schematic view showing an aspect of implementing a touch pad according to the present invention.

FIG. 3 is a schematic view showing an accommodation of a touch pad and a computer system according to the present invention.

FIG. 4 is a view showing a systematic configuration of a touch pad according to a preferred embodiment of the present invention.

### DETAILED DESCRIPTION OF THE PREFERRED EMBODIMENT

A preferred embodiment of the invention will be described with reference to the accompanying drawings for illustrating the present invention.

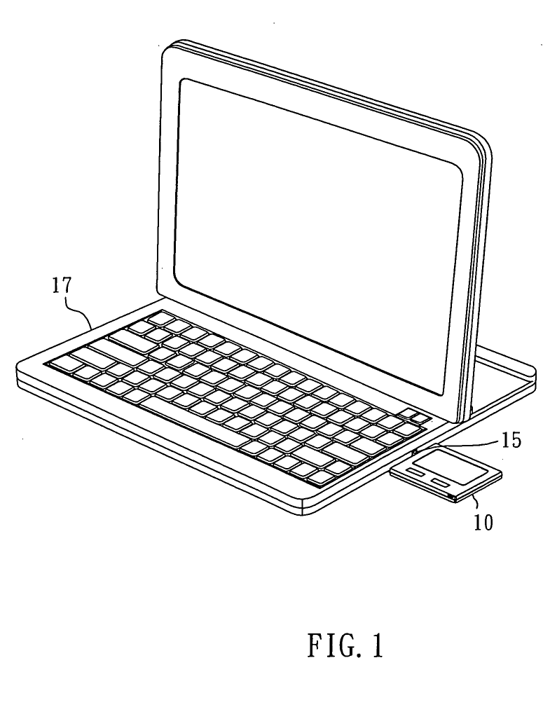

Referring to FIG. 1, a schematic view showing an aspect of implementing the present invention is illustrated. A touch pad 10 and a computer system 17 are shown, having a connecting port 15 mounted on the touch pad 10 for connecting to the computer system 17. The computer system 17 can be a notebook PC, a tablet PC or a desktop PC. The connecting port 15 is a USB device. Hence, the touch pad 10 can be easily connected to the computer system 17. The touch pad 10 stores data such as an address book, a calendar, a perpetual calendar and the like being frequently added, modified or deleted when the user uses the computer, for example. As such, the data of the touch pad 10 and data of the computer system 17 are refreshed synchronously by the USB interface to maintain data consistency between the touch pad 10 and the computer system 17.

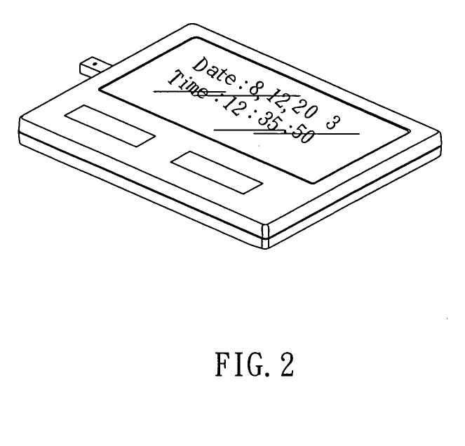

Referring to FIG. 2, a schematic view showing an aspect of implementing the present invention is illustrated. After the touch pad 10 is detached from the computer system (when the computer system is in a power-down state) the user can employ the touch pad 10 alone to search time data. In addition, the touch pad 10 can be used to search various data such as a calendar, an address book and the like. Thus, the user does not spend time in waiting for powering up the computer when searching a datum.

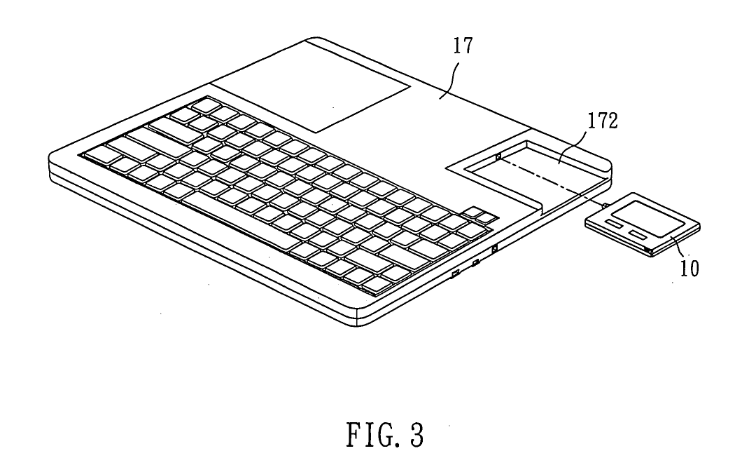

FIG. 3 is a schematic view showing an aspect of implementing the present invention. When the touch pad 10 is in an unused state, it is accommodated in a receiving slot 172 indented into the computer system 17. The touch pad 10 is placed in the receiving slot 172 when the touch pad 10 is not operated by the user so as to facilitate the user's storage or carry.

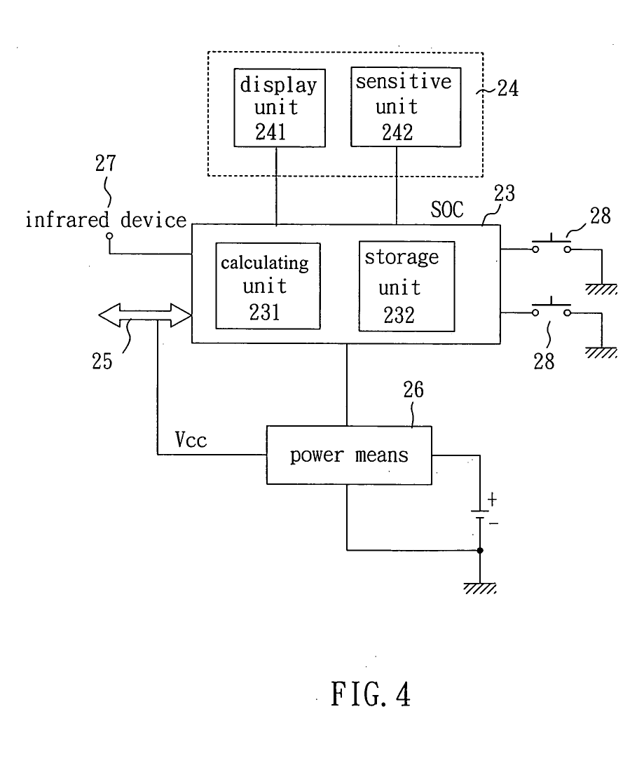

As for the configuration of a touch pad for displaying information according to the present invention, reference is made with FIG. 4. As shown, the touch pad comprises a calculating unit 231, a storage unit 232, a display unit 24 and a connecting port 25. The calculating unit and the storage unit of the present invention can be of any conventional units, respectively. Preferably, the calculating unit and the storage unit are integrated into a system on a chip (SOC) 23. In this embodiment, the calculating unit 231 and the storage unit 232 are integrated into a SOC 23 having an embedded system. The storage unit 232 stores data such as an address book, a calendar and the like. The display unit 24 comprises a display board 241 and a sensitive board 242, being connected to the SOC 23. The display board 241 displays the data stored in the storage unit 232. The sensitive board 242 provides the user with a way for searching data selected directly from the touch pad 20 by manual touch. In this embodiment, the connecting port 25 is a USB device connected to the SOC 23. In addition, the touch pad of the present invention further comprises a power means for separately and individually supplying power for operation. Preferably, the power means is connected to the connecting unit and the SOC. The computer system supplies power to the touch pad when the touch pad is connected to the computer system, while the power means supplies power to the touch pad when the touch pad is detached from the computer system. In this embodiment, the touch pad 20 further comprises a power means 26. The power means 26 is connected to the connecting unit 15 and the SOC 23. The computer system 17 supplies power to the touch pad 10 via the USB device when the touch pad 10 is connected to the computer system 17, while the power means 26 supplies power to the touch pad 10 to be operated separately and individually when the touch pad 10 is detached from the computer system 17. Furthermore, an infrared device 27 is disposed on the touch pad for mutual data communication. The touch pad further comprises a keystroke 28 to facilitate the user's selection of data.

It is apparent from the above description that the present invention is capable of providing the user with a convenient and easy way for searching data desired by means of a touch pad when the computer system is in a power-down state without wasting time in waiting for powering up the computer. Also, the touch pad is designed to provide the user with a manual data search by means of a small-sized panel convenient to be carried by the user.

Although the present invention has been explained in relation to its preferred embodiments, it is to be understood that many other possible modifications and variations can be made without departing from the spirit and scope of the invention as hereinafter claimed.

1. A touch pad for displaying information, comprising:
a calculating unit;
a storage unit for storing data;
a display unit connected to said calculating unit and said storage unit, wherein said display unit has a display board and a sensitive board; and
a connecting port for connecting to a computer system so that said touch pad is electrically connected to and detachable from said computer system and the data stored in said storage unit and data of the computer system synchronize.

2. The touch pad for displaying information of claim 1, wherein said calculating unit and said storage unit are integrated into a system on a chip (SOC).

3. The touch pad for displaying information of claim 2, wherein said touch pad further comprises a power means connected to said connecting unit and said SOC for separately and individually supplying power for operation so that said computer system supplies power to said touch pad when said touch pad is connected to said computer system while said power means supplies power to said touch pad when said touch pad is detached from said computer system.

4. The touch pad for displaying information of claim 1, wherein said touch pad can be operated separately and individually after detaching said touch pad from said computer system.

5. The touch pad for displaying information of claim 1, wherein said display board displays said data stored in said storage unit while said touch pad is used to search data by touch control.

6. The touch pad for displaying information of claim 1, wherein said connecting port 15 is a USB device.

7. The touch pad for displaying information of claim 1, wherein at least a keystroke is disposed on said touch pad for searching data.

8. The touch pad for displaying information of claim 1, wherein said touch pad further comprises an infrared device.
